(19) United States
(12) Patent Application Publication
(10) Pub. No.: US 2008/0055930 A1
(43) Pub. Date: Mar. 6, 2008

(54) Backlight module

(75) Inventor: Chung-Ming Huang, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-BRIDGE ELECTRONICS CO. , LTD.

(21) Appl. No.: 11/654,034

(22) Filed: Jan. 17, 2007

(30) Foreign Application Priority Data
Aug. 31, 2006 (TW) 095215501

(51) Int. Cl. F21V 7/04

(52) U.S. Cl. 362/612; 362/613

(57) ABSTRACT

A backlight module includes multiple light sources and optical films; those optical films being disposed over those light sources to allow streams of light emitted from each light source radiate through those optical films to reach the expected performance of light source; those light sources being arranged in proper spacing; those diffusion films being arranged over those light sources in the same spacing of that for those light sources; and diffusion effects by those diffusion films reducing luminance over those light sources to correct the phenomenon of producing darker and brighter bands in the backlight module.

### BACKGROUND OF THE INVENTION

(a) Field of the Invention

The present invention is related to an improved structure of a backlight module, and more particularly, to one that is capable of effectively distributing streams of light emitted from a light source without developing darker and brighter light bands.

(b) Description of the Prior Art

Direct or side emitting backlight module configuration may be selected for the liquid crystal displays generally applied in information systems depending on the design requirements. As illustrated in FIG. 1 showing a schematic view of a basic structure of a direct backlight module configuration, the structure of the entire backlight module is outwardly disposed in sequent a reflection mask 11, multiple light sources 12, a diffuser 13, multiple optical films 14, and a liquid crystal panel 15. Wherein, each light source 12 may be related to a tube in straight, U-shaped, or other continuously curved form; and all light sources are arranged with proper spacing at where between the reflection mask 11 and the diffuser 13. Those multiple optical films 14 generally available in the market are comprised of one up to three diffusers, none, one or two light enforcement films, and none or one reflection type of polarized film to diffuse the stream of light passing through those films thus to correct the problem of producing darker and brighter bands on the liquid crystal module at where directly in front of the spacing between any two light sources due to no stream of light is produced.

Furthermore, the diffuser 13 operates only for consistent emission of stream of light passing through the diffuser 13 its effect to correct the darker and brighter bands on the liquid crystal module is very limited. Therefore, an improvement has been introduce to deliberately extend the gap between the light source 12 and the diffuser 13 in the hope to diminish the darker band by expanding the range of the stream of light entering from each light source 12 into the diffuser 13. However, the structural design for the improvement provides very limited effects to solve the problem of creating darker and brighter bands on the liquid crystal module while thickening the liquid crystal module in going against the basic design requirements of having a compact liquid crystal module.

### SUMMARY OF THE INVENTION

The primary purpose of the present invention is to provide an improved structure of a backlight module to correct the problem of developing darker and brighter bands on a liquid crystal module as found with the prior art.

To achieve the purpose, a backlight module of the present invention includes multiple light sources and optical films. Each optical film is disposed over the top of the light source so that the stream of light emitted form the light source is emitted through the optical film to reach the expected performance of the light source. Wherein, those light sources are arranged in a proper spacing; and multiple diffusers provided above those light sources are also arranged in the same spacing as that for those light sources so that the luminance above the light sources is reduced through the diffusion effects provided by those diffusers to correct the phenomenon of the darker and brighter bands for the backlight module.

### BRIEF DESCRIPTION OF THE DRAWINGS

FIG. 1 is a schematic view of a structure of a backlight module of the prior art.

FIG. 2 is a schematic view of a structure of a backlight module of the present invention.

FIGS. 3(A) and 3(B) are perspective views of the backlight module of the present invention.

FIG. 4 is a schematic view showing a traveling route of stream of light emitted from the backlight module of the present invention.

FIG. 5 is a perspective view showing a structure of multiple diffusion films of the present invention before being molded.

FIG. 6 is a perspective view showing a structure of multiple diffusion films of the present invention that are molded.

FIG. 7 is a schematic view showing another structure of the backlight module of the present invention

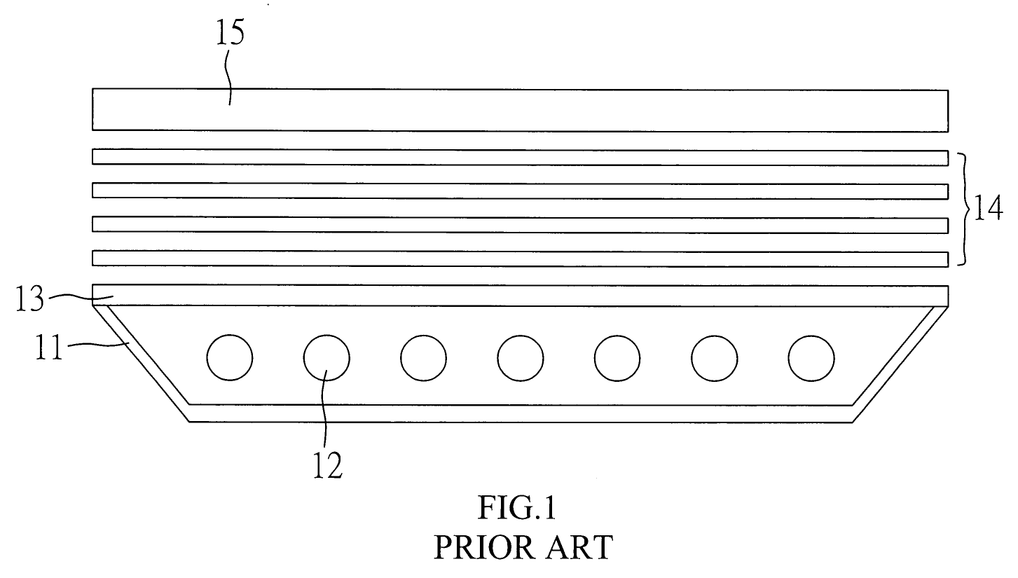

### DETAILED DESCRIPTION OF THE PREFERRED EMBODIMENTS

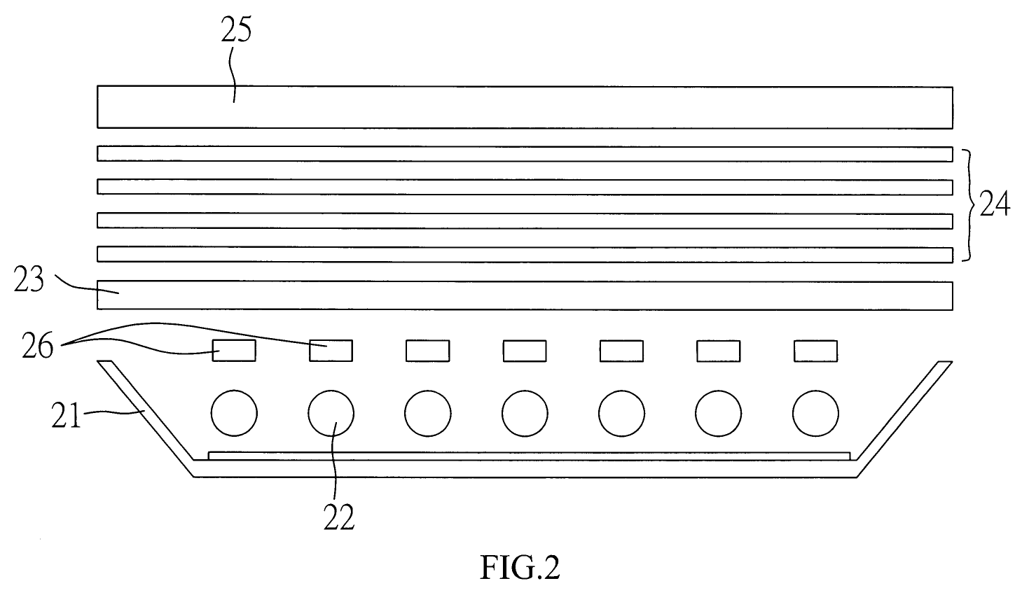

Referring to FIG. 2, an improved structure of a backlight module of the present invention has multiple light sources 22 disposed in a reflection mask 21; a diffuser 23 disposed over the top of those light sources and multiple optical films 24 over the diffusion plate 23; and a liquid crystal panel 25 over those optical films 24. Wherein, each light source is related to a tube in a form of straight, U-shaped, or any other form with continuous curves, or a light emitting diode with all light sources 22 arranged with a proper spacing between the reflection mask 21 and the diffuser 23; and those multiple optical films 24 disposed between the diffuser plate 23 and the liquid crystal panel 25 are comprised of one up to three diffusion films, none or one or two light enforcement films, and none or one reflective type of polarized light film.

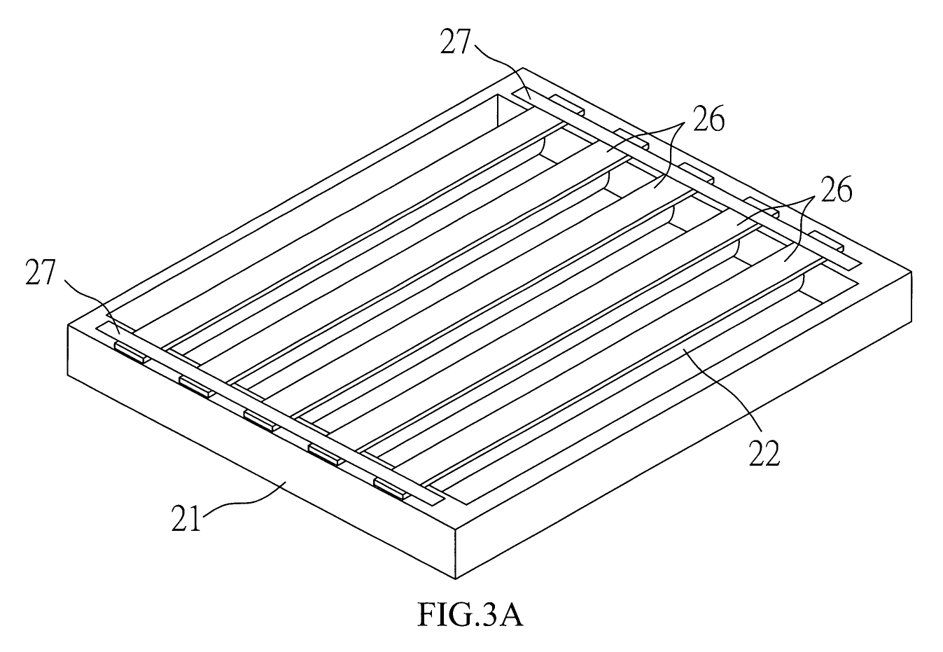

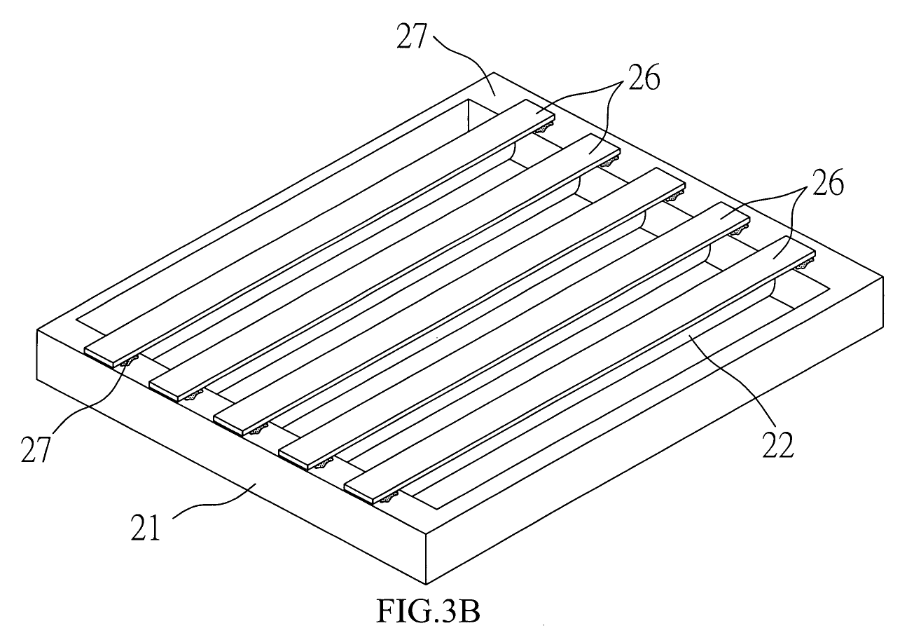

The present invention is characterized in that multiple diffusion films 26 arranged in a spacing same as that for those light sources 22 over those light sources 22 as also illustrated in FIGS. 3(A) and 3(B). Each diffusion film 26 is secured in position to the reflection mask 21 by means of a locating device 27, which may be related to an adhesive tape, adhesion, or any other locating means so to secure each diffusion film 26 to where above its respective light source 22.

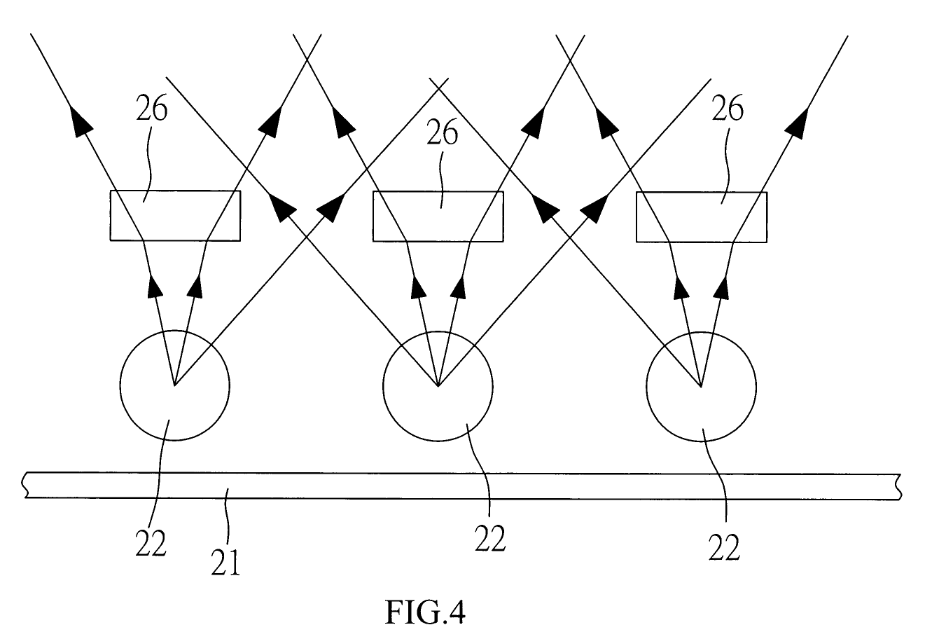

In practice, luminance of those streams of light emitted from and above those light sources 22 as illustrated in FIG. 4 are reduced due to diffusion effects provided by those diffusion films 26 while the luminance of the streams of light emitted from those light sources 22 through gap between any two abutted light sources 22 becomes equivalent to that of the streams of light emitted through those diffusion films 26 over those light sources 22 thus to correct the darker and bright bands produced in the backlight module.

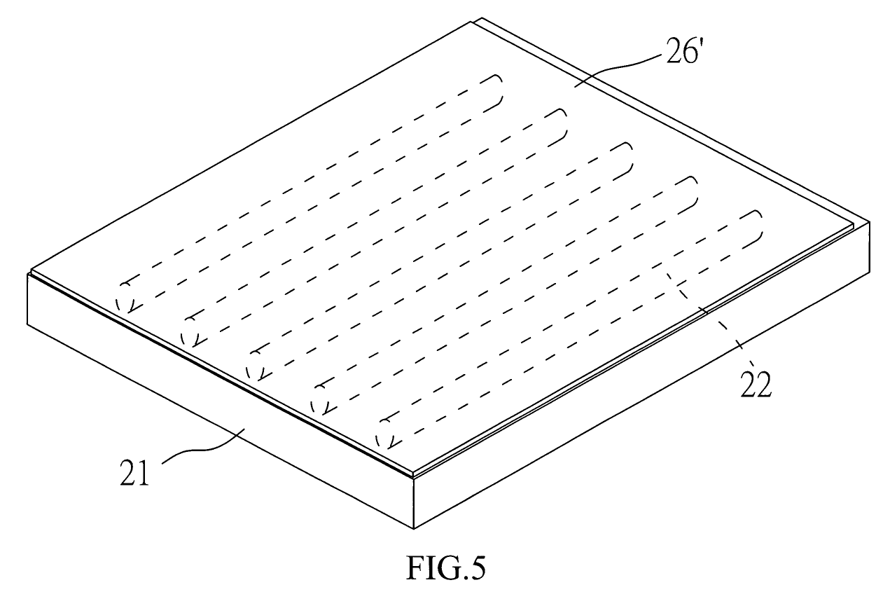

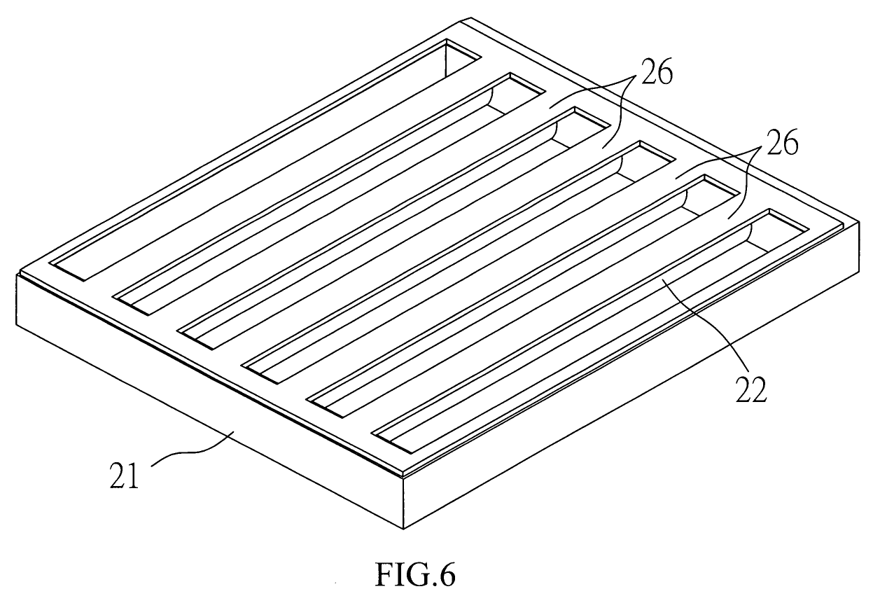

Furthermore, a entire sheet of diffusion film 26′ is pre-fixed to where above those light sources 12 as illustrated in FIG. 5. Wherein, the diffusion film 26′ covers over the top of those light sources 22; and then each spacing between the diffusion film 26′ and each light source 22 is removed to become a structure as illustrated in FIG. 6 wherein those diffusion films 26 arranged with the same spacing as that for those multiple light sources 22 are provided over each light source 22.

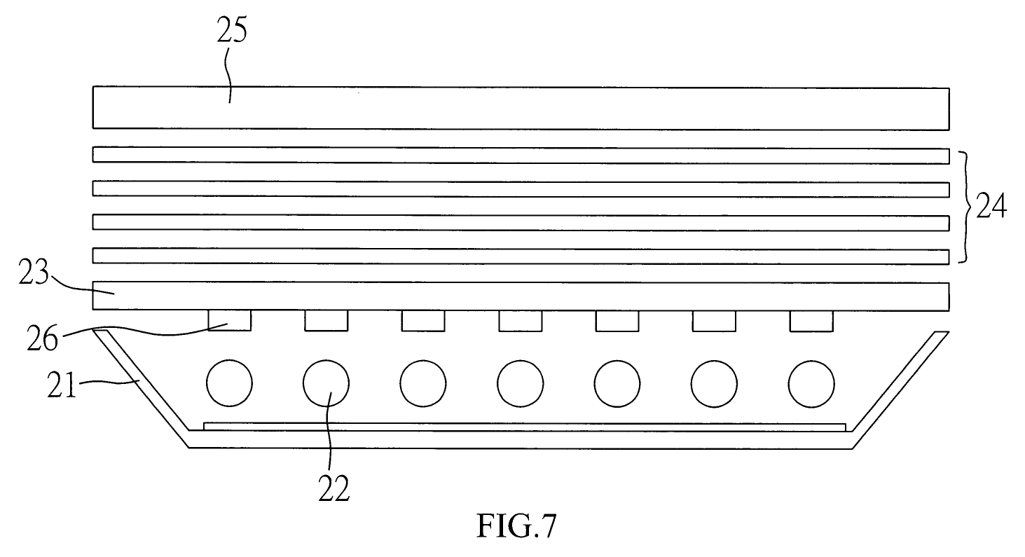

Alternatively, each diffusion film 26 may be secured by means of the locating device (e.g., adhesive tape or adhesion not illustrated) to where below the diffusion plate 23 relatively to the top over each light source 22 as illustrated in FIG. 7 to achieve the same purpose of reducing the luminance of stream of light and correcting the phenomenon of darker and brighter bands in the backlight module.

The prevent invention provides an improved structure of a backlight module, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A backlight module including multiple light sources arranged in a proper spacing; multiple diffusion films provided over the top of those light sources and arranged in the same spacing as that for those light sources; a diffuser disposed over those diffusion films; and an optical film disposed over the diffuser.

2. The backlight module as claimed in claim 1, wherein those light sources are disposed in a reflection mask.

3. The backlight module as claimed in claim 2, wherein each diffusion film is secured in position to the reflection mask by means of a locating device.

4. The backlight module as claimed in claim 1, wherein each diffusion film is secured in position at where below the diffuser by means of a locating device.

5. The backlight module as claimed in claim 3, wherein the locating device is a adhesive tape or adhesion.

6. The backlight module as claimed in claim 4, wherein the locating device is a adhesive tape or adhesion.

7. The backlight module as claimed in claim 1, wherein the optical film further includes one up to three diffusion films, none, one or two light enforcement films; and none or one reflective type of polarized film.

8. The backlight module as claimed in claim 1, wherein the light source is related to a tube in a form of straight, U-shaped, or other form in continuous curves.

9. The backlight module as claimed in claim 1, wherein the light source is related to a light emitting diode.

10. The backlight module as claimed in claim 1, wherein, an entire sheet of a diffusion film is pre-fixed to where above those light sources; the diffusion film covering over the top of those light sources; spacing between the diffusion film and each light source being removed; and multiple diffusion films being arranged over the top of those light sources in the same spacing as that for those light sources.
